(19) United States
(12) Patent Application Publication
(10) Pub. No.: US 2007/0137965 A1
(43) Pub. Date: Jun. 21, 2007

(54) SEAT ADJUSTING APPARATUS FOR VEHICLE

(75) Inventors: Yukifumi Yamada, Toyota-shi (JP); Yasuhiro Kojima, Kariya-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: AISIN SEIKI KABUSHIKI KAISHA, Kariya-shi (JP)

(21) Appl. No.: 11/614,385

(22) Filed: Dec. 21, 2006

(30) Foreign Application Priority Data
Dec. 21, 2005 (JP) 2005-368630
Dec. 22, 2005 (JP) 2005-369592

(51) Int. Cl. B60N 2/16; A47C 1/025

(52) U.S. Cl. 192/19; 192/223.2; 297/344.12

(57) ABSTRACT

The seat adjusting apparatus includes: an input side member connected to the operating lever and rotatably supported by the output shaft; a control member arranged at a radially outer side of the input side member; a first clutch mechanism transmitting operation force of the operating member from the input side member to the control member when the operating lever is driven to operate and discontinuing force transmission between the input side member and the control member when the operating member returns to an original position; and a second clutch mechanism transmitting the operation force of the operating member from the control member to the output shaft when the operating member is driven to operate and restraining the output shaft from rotating when the operating member is not driven to operate.

### CROSS REFERENCE TO RELATED APPLICATIONS

This application is based on and claims priority under 35 U.S.C. §119 with respect to Japanese Patent Application 2005-368630, filed on Dec. 21, 2005, and 2005-369592, filed on Dec. 22, 2005, the entire content of which is incorporated herein by reference.

### FIELD OF THE INVENTION

The present invention relates to a seat adjusting apparatus for a vehicle, which adjusts a height of a seat cushion. More specifically, the present invention pertains to a clutch mechanism of a seat adjusting apparatus for a vehicle.

### BACKGROUND

Conventionally known are seat adjusting apparatuses for vehicles, which adjust the height of a seat cushion. In such seat adjusting apparatus, the height of the seat cushion is adjusted upon an operation of an operating lever in cases where an occupant is seated on the seat.

For example, according to a seat adjusting apparatus for a vehicle disclosed in JP2002-54658A (FIG. 1), provided are a first clutch mechanism and a second clutch mechanism which are to adjust the height of the seat cushion with torque inputted thereto from the operating lever pivoted in a normal or reverse direction and to retain the position of the seat cushion in situations where the operating lever is released. Once the operating lever receives operation force, in the first clutch mechanism, the operation force is transmitted from an outer race equipped with the operating lever to an inner race via rollers. The operation force is then transmitted from an inner race of the second clutch mechanism to an output shaft. As described above, the operation force of the operating lever is transmitted to the output shaft. When the operating lever is not actuated to operate, the second clutch mechanism prohibits the output shaft from rotating.

However, in the above-described seat adjusting apparatus for a vehicle, the first and second clutch mechanisms are each structured in a way that force is transmitted in a radially inward direction thereof. Therefore, a return spring is positioned between the first and second clutch mechanisms, which are axially arranged, which return spring acts to return the outer race of the first clutch mechanism to a neutral position. Therefore, the first and second clutch mechanisms are arranged in an axially spaced-apart relationship, wherein a control member, which transmits rotational force from the first clutch mechanism to the second clutch mechanism, is excessively elongated in an axial direction. In such circumstances, the control member is required to have mechanical rigidity large enough against large torsional force. For example, although the control member can be thickened in a radial direction to have larger mechanical rigidity, this causes enlargement of the clutch mechanism or of the seat adjusting apparatus.

Further, the outer race of the first clutch mechanism is subjected, at its cam surface (inner circumferential surface) via the rollers, with force projecting radially outwardly. The outer race is hence required to be thick-walled against deformation due to the force projecting radially outwardly. However, this causes enlargement of the apparatus as well.

The present invention has been made in view of the above circumstances, and provides a downsized seat adjusting apparatus for a vehicle which is downsized.

### SUMMARY OF THE INVENTION

According to an aspect of the present invention, a seat adjusting apparatus for a vehicle has a seat lifted up and down in response to a rotation of an output shaft following an operation of an operating lever. The seat adjusting apparatus includes: an input side member connected to the operating lever and rotatably supported by the output shaft; a control member arranged at a radially outer side of the input side member; a first clutch mechanism transmitting operation force of the operating member from the input side member to the control member when the operating lever is driven to operate and discontinuing force transmission between the input side member and the control member when the operating member returns to an original position; and a second clutch mechanism transmitting the operation force of the operating member from the control member to the output shaft when the operating member is driven to operate and restraining the output shaft from rotating when the operating member is not driven to operate.

### BRIEF DESCRIPTION OF THE DRAWINGS

The foregoing and additional features and characteristics of the present invention will become more apparent from the following detailed description considered with reference to the accompanying drawings, wherein:

FIG. 1 is a perspective view of a seat for a vehicle;

FIG. 2 is a perspective view of a seat adjusting apparatus for a vehicle according to an embodiment of the present invention;

FIG. 3 is an exploded perspective view of a clutch mechanism;

FIG. 4 is a sectional view of the clutch mechanism;

FIG. 5 is a sectional view taken along line V-V in FIG. 4;

FIG. 6 is an explanatory view of an input side member;

FIG. 7 is a sectional view taken along line VII-VII in FIG. 4;

FIG. 8 is an explanatory view of a return spring; and

FIG. 9 is a front view of a spiral spring.

### DETAILED DESCRIPTION

An embodiment of the present invention is described below with reference to the attached drawings.

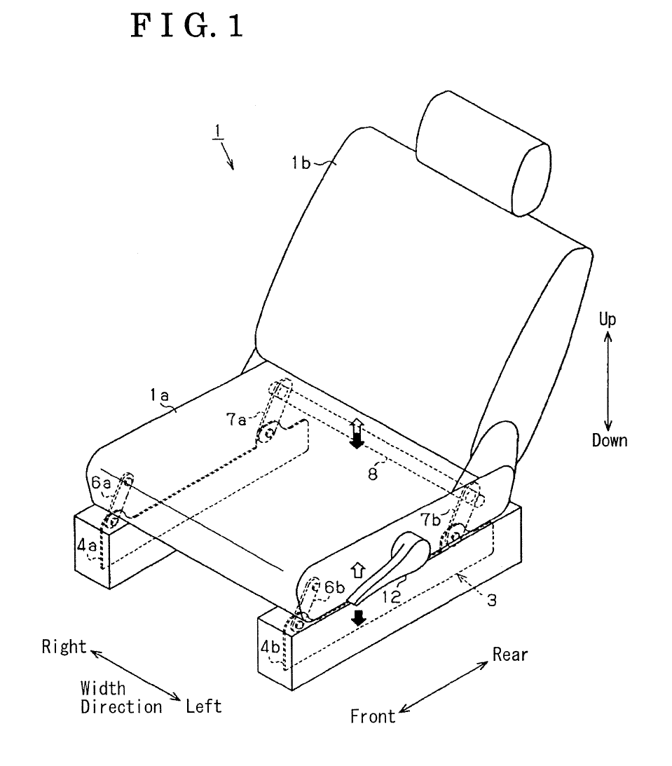

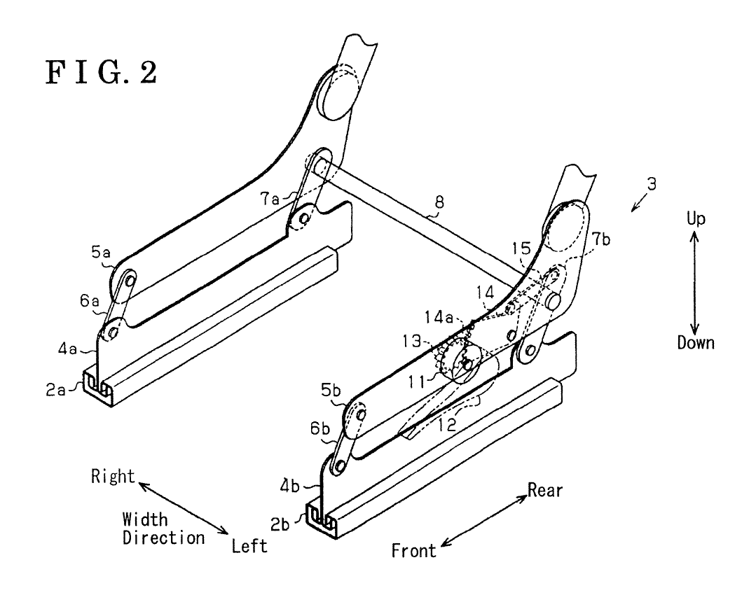

As illustrated in FIGS. 1 and 2, a seat 1 for a vehicle includes a seat cushion 1a and a seatback 1b extending in an inclined upward direction from a rear end upper surface of the seat cushion 1a. The seat 1 is supported to be rotatable over lower rails 2a and 2b secured to a floor of the vehicle. Provided is a seat adjusting apparatus 3 under the seat cushion 1a, which adjusts the height or the surface level of the seat cushion 1a.

The lower rails 2a and 2b are mounted with the upper rails 4a and 4b slidable over the lower rails 2a and 2b. The upper rails 4a and 4b support base frames 5a and 5b of the seat cushion 1a to be lifted up and down, respectively.

Lifter links 6a and 7a are supported at front and rear ends of the upper rail 4a so as to pivot about lower ends, respectively. The lifter links 6a and 7a are further connected to front and rear ends of the base frame 5a so as to pivot about upper ends, respectively. Likewise, lifter links 6b and 7b are supported at front and rear ends of the upper rail 4b so as to pivot about lower ends, respectively. The lifter links 6b and 7b are further connected to front and rear ends of the base frame 5b so as to pivot about upper ends, respectively. The joining point between the lifter link 7a and the base frame 5a is connected to the joining point between the lifter link 7b and the base frame 5b via an approximately cylindrical torque rod 8. Therefore, the base frames 5a and 5b are interlocked with each other to be lifted up and down.

The base frame 5b is equipped with a clutch mechanism 11 configuring the seat adjusting apparatus 3. An operating lever 12, which serves as an operating member, is attached to the clutch mechanism 11. A pinion gear 13 is mounted at an output shaft of the clutch mechanism 11. The pinion gear 13 rotates in response to operation of the operating lever 12. A sector gear 14 is supported at the base frame 5b behind the clutch mechanism 11 so as to rotate about its lower base end. The sector gear 14 is formed, at a distal end, with teeth 14a engaged with the pinion gear 13. The sector gear 14 is hence rotated in response to rotation of the pinion gear 13. An upper base end of the sector gear 14 is connected to an upper end of the lifter link 7b via the driving link 15 in a manner that the driving link 15 allows the sector gear 14 and the lifter link 7b to pivotably rotate. Therefore, once the sector gear 14 is pivoted, the lifter link 7b is pivoted via the driving link 15 and the lifter link 7a is pivoted via the torque rod 8, wherein the base frames 5a and 5b are interlocked with each other to be lifted up or down.

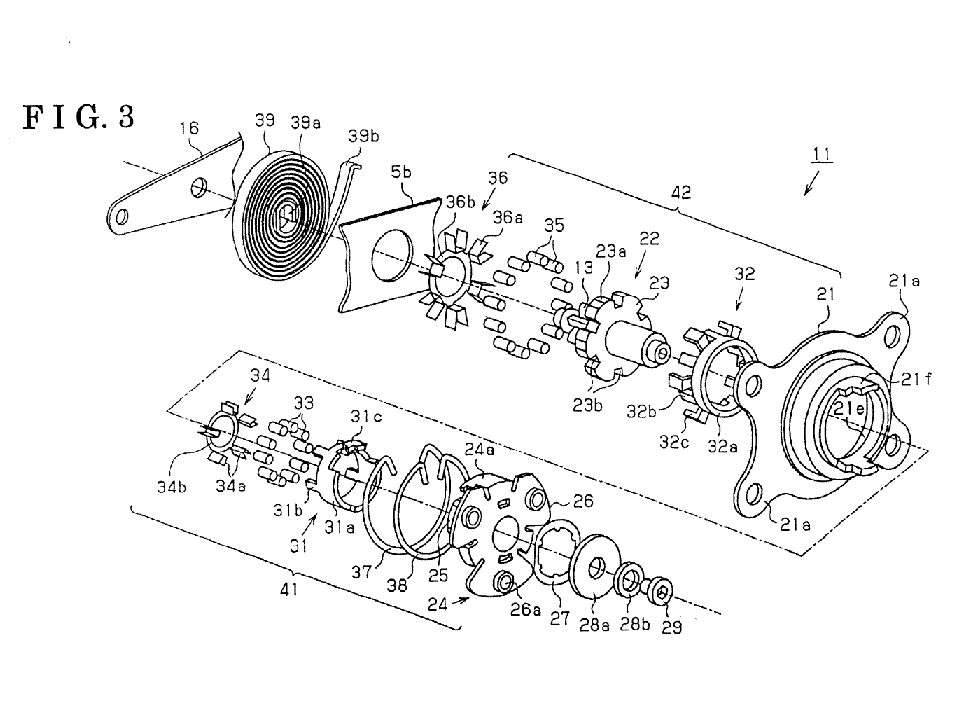

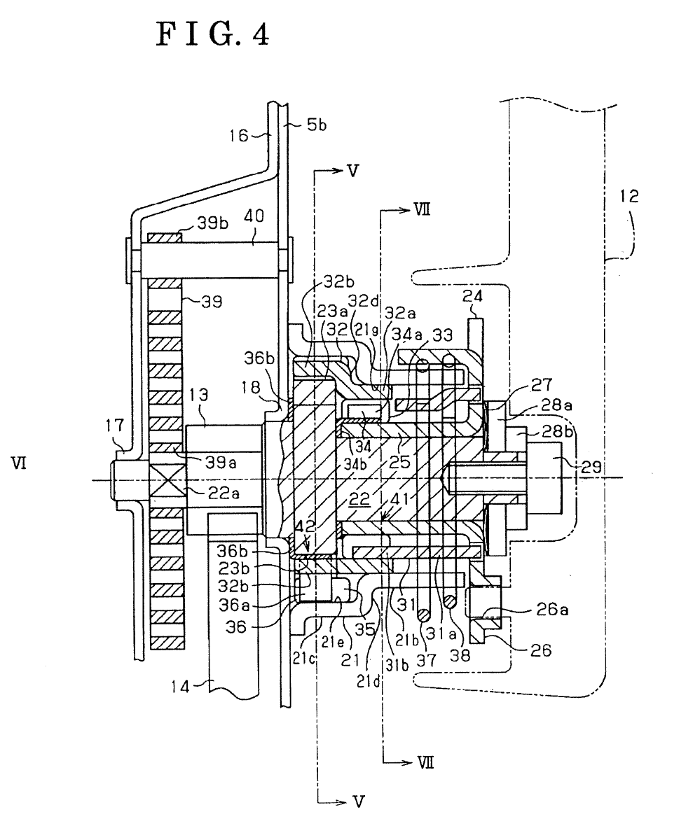

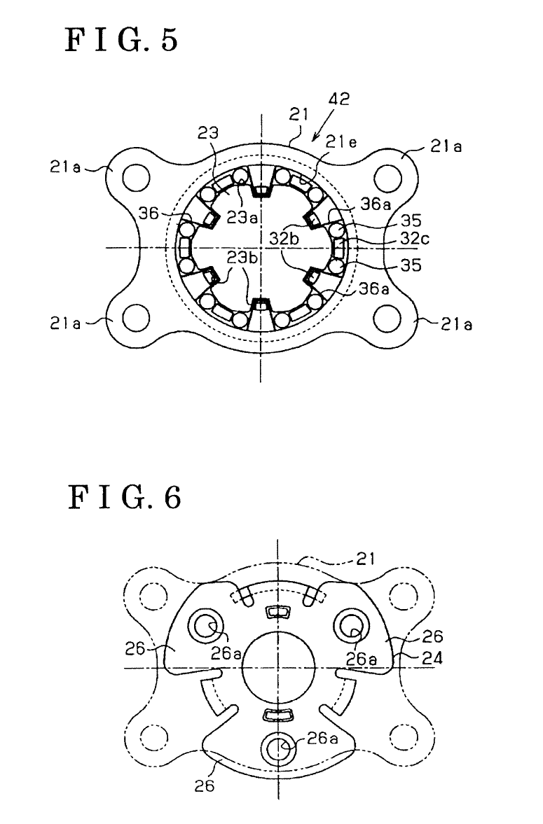

Described below is a detailed structure of the clutch mechanism 11. As illustrated in FIGS. 3 and 4, the clutch mechanism 11 includes an approximately cylindrically shaped case 21 as a static member. As illustrated in FIG. 5, the case 21 is fixedly attached to the base frame 5b via multiple attaching portions 21a protruding outwardly in a radial manner. Further, the case 21 is formed with a reduced diameter portion 21b at the side of the operating lever 12 and an enlarged diameter portion 21c as a cylindrical portion at the opposite side to the operating lever 12. The reduced diameter portion 21b is connected to the enlarged diameter portion 21c via a stepped portion 21d extending in a radial direction. An output shaft 22 is positioned inside the case 21 and is freely rotatably supported by the base frame 5b.

The output shaft 22 is integrally formed with a rotor cam 23 at the side of the operating lever 12 of the base frame 5b. The output shaft 22 is further formed integrally with the pinion gear 13 at an opposite side to the operating lever 12 of the base frame 5b. The rotor cam 23 exhibits an approximately hexagonal shape having an outer surface as a cam surface 23a and grooves 23b each defined at an intermediate of the corresponding edge of the hexagonal surface. According to the embodiment of the present invention, each groove 23b is formed in a radial direction so as to open at the corresponding edge of the cam surface 23a. The rotor cam 23 and the pinion gear 13 are each formed integrally with the output shaft 22. However, the rotor cam 23 and the pinion gear 13 can be each separated from the output shaft 22 and can rotate integrally therewith.

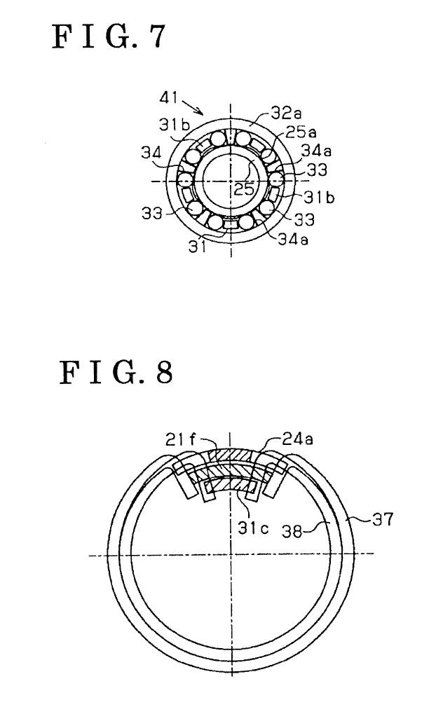

Further, the output shaft 22 supports an input side member 24 to be freely rotatable, which input side member 24 is attached with the operating lever 12. As illustrated in FIG. 4, the input side member 24 includes an inner race 25, which is formed in an approximately cylindrical shape and into which the output shaft 22 is inserted, and a planar-shaped lever contact portion 26, which extends from the inner race 25 outwardly in a radial manner. As illustrated in FIG. 6, the lever contact portion 26 are formed with plural bores 26a (three bores in FIG. 6) into which the operating lever 12 is fitted. The bores 26a are arranged in the circumferential direction. Therefore, the input side member 24 can rotate in response to operation of the operating lever 12. As is apparent from FIGS. 3 and 4, attached to a distal end of the output shaft 22 are an elastic member 27, which is made of a waved spring or a disc spring, washers 28a and 28b, by means of a bolt 29. The input side member 24 is biased in the axial direction by biasing force of the elastic member 27. As viewed from a cross section in which its axis penetrates at right angles in FIG. 7, the inner race 25 exhibits an annular shaped inner periphery and approximately pentagonal shaped outer periphery, and the outer peripheral surface of the inner race 25 serves as a cam surface 25a.

Further, as illustrated in FIGS. 3 and 4, a return member 31 and a control member 32 are arranged at a radially outward side of the input member 24 inside the case 21. The return member 31 is idly fitted at a radially outward side of the inner race 25. The return member 31 includes a cylindrical portion 31a and plural engagement portions 31b extending in the axial direction from the cylindrical portion 31a and protruding to the opposite side to the operating lever 12. The quantity of the engagement portions 31b of the return member 31 depends of the shape of the inner race 25 of the input member 24. According to the embodiment of the present invention, there are five engagement portions 31b arranged at the same interval in the circumferential direction.

The control member 32 is idly fitted at the radially outward side of the return member 31. The control member 32 includes an annular shaped outer race 32a, first engagement portions 32b and second engagement portions 32c. The first and second engagement portions 32b and 32c protrude along the axial direction from the outer race 32a to the opposite side to the operating lever 12 and are arranged in turn along the circumferential direction. The outer race 32a is positioned at the radially outward side of the engagement portions 31b of the return member 31. A diameter of the outer peripheral surface of the outer race 32a is approximately identical to the diameter of the inner circumferential surface of the reduced diameter potion 21e of the case 21. That is, the outer peripheral surface of the outer race 32a is in pressure-contact with the inner peripheral surface 21g of the reduced diameter portion 21b. Each first engagement portion 32b is formed continuously from the control member 32 in the axial direction and is fitted with a predetermined looseness into the corresponding groove 23b of the rotor cam 23. Each second engagement portion 32c is formed into an approximately L-shaped structure having the stepped portion 32d extending radially outwardly from the outer race 32a. A portion of each second engagement portion 32c, which extends axially, is arranged to be radially more outward than the first engagement portions 32b.

As illustrated in FIGS. 4 and 7, multiple spaces (five) are defined, which are surrounded by the cam surface 25a of the inner race 25, the inner circumferential surface 32d of the outer race 32a of the control member 32, the return member 31 and the rotor cam 23. The five spaces are arranged along the cam surface 25a and are separated by the engagement portions 31b. Because the inner circumferential surface of the outer race 32a exhibits an approximately cylindrical shape and the cam surface 25a of the inner race 25 exhibits a polygonal shape, each space exhibits a shape where a distance between the inner circumferential surface of the outer race 32a and the cam surface 25a of the inner race 25 is gradually reduced towards its ends in the circumferential direction. As illustrated in FIG. 7, each space houses therein two first rollers 33, and a first looseness preventive spring 34 is inserted into the two first rollers 33 in each space. As illustrated in FIG. 3, the first looseness preventive spring 34 includes spring portions 34a each arranged between the corresponding first rollers 33 and a connecting portion 34b connecting the plural spring portions 34a. Each spring portion 34a biases the first rollers 33 arranged at both circumferential sides thereof and exerts a biasing force in the same directions. Accordingly, each spring portion 34a biases the first rollers 33 toward the tops of the inner race 25 having the outer peripheral surface formed into an approximately polygonal shape, i.e., biases the first rollers 33 toward ends of the corresponding space which is a narrowed and wedge-shaped space defined by the cam surface 25a of the inner race 25 and the circumferential surface 32d of the control member 32 facing the cam surface 25a in the radial direction.

As illustrated in FIGS. 3 and 7, the first clutch mechanism 41 is structured, as described above, with the input member 24 (inner race 24), the return member 31, the first rollers 33, the first looseness preventive spring 34 and the control member 32 (outer race 32a). The stepped portion 21d of the case 21 and the stepped portion 32d of the control member 32 are arranged at the radially outward side of the first clutch portion 41.

As is apparent from FIGS. 4 and 5, defined are plural spaces, which are surrounded by the cam surface 23a of the rotor cam 23, the inner circumferential surface 21e of the case 21 and the base frame 5b and are defined by the second engagement portions 32c of the control member 32. The spaces are arranged along the cam surface 23a of the rotor cam 23. According to the embodiment of the present invention, there are six spaces being defined. As described above, the cam surface 23a of the rotor cam 23 is formed into a polygonal shape and the inner circumferential surface 21e of the case 21 is formed into a cylindrical shape, which provides a basis of that each space exhibits a shape in which a distance between the inner circumferential surface 21e and the cam surface 23a is reduced gradually towards its circumferential directional ends. The two second rollers 35 as the second rotors are accommodated in each space. According to the embodiment of the present invention, the first rollers 33 and the second rollers 35 are arranged in a manner of overlapping each other in the axial direction.

As is obvious from FIG. 5, accommodated in each space are two second rollers 35 and a second looseness preventive spring 36 inserted into the two second rollers 35 in the respective spaces. Going back to FIG. 3, the second looseness preventive spring 36 includes spring portions 36a each arranged in the two corresponding second rollers 35 in each space and a connecting portion 36b connecting the plural spring portions 36a. Each spring portion 36a biases the corresponding second rollers 35 toward the tops of the rotor cam 23 having the outer circumferential surface formed into an approximately polygonal shape, i.e., biases the corresponding second rollers 35 toward ends of the corresponding space which is a narrowed and wedge-shaped space defined by the cam surface 23a of the rotor cam 23 and the inner circumferential surface 21d of the case 21 facing the cam surface 23a in the radial direction. Each second engagement portion 32c formed at the control member 32 is arranged at an end of the narrowed and wedge-shaped space and is arranged between the second rollers 35 in the circumferential direction. According to the embodiment of the present invention, a clearance between the second roller 35 and the second engagement portion 32c is smaller than a circumferential directional clearance between the base of the spring portion 36a and the first engagement portion 32b

As illustrated in FIGS. 3 and 6, a second clutch mechanism 42 is structured, as described above, with the control member 32 (the first engagement portions 32b and the second engagement portions 32c), the rotor cam 23, the second rollers 35, the second looseness preventive spring 36 and the case 21. According to the embodiment, the first clutch mechanism 41 and the second clutch mechanism 42 are arranged in the vicinity of each other in the axial direction.

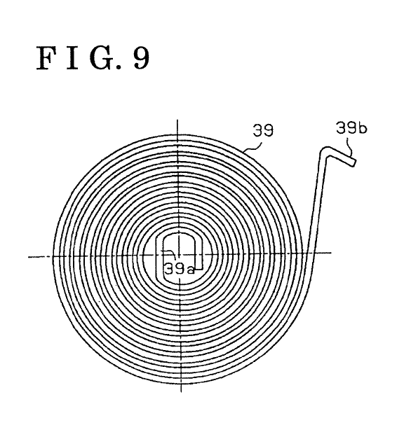

Further, as illustrated in FIG. 3, hook portions 21f, 24a and 31c are respectively formed at the case 21, the input member 24 and the return member 31 so as to overlap one another in the radial direction. As illustrated in FIG. 8, each hook portion 21f, 24a and 31c is engaged with return springs 37 and 38, which serve as returning member, and is biased by biasing force of the return springs 37 and 38 to rotate to a position where they overlap one another in the radial direction. Therefore, each hook portions 21f, 24a and 31c can return the input member 24 and the return member 31 to a neutral position corresponding to the hook portion 21f of the case 21. According to the embodiment of the present invention, the return springs 37 and 38 are arranged in the vicinity of the operating lever 12 in the axial direction.

Further, as illustrated in FIG. 4, the base frame 5b is firmly attached with an auxiliary frame 16 at a position where the clutch apparatus 11 is supported. The auxiliary frame 16 is secured, at its base end portion, to the base frame 5b for example by means of a bolt, and an opening end of the auxiliary frame 16 extends so as to be in parallel to the base frame 5b with a predetermined distance.

The auxiliary frame 16 is formed with a through hole to be a first bearing 17, while the base frame 5b is formed with a through hole to be a second bearing 18 arranged to be coaxial with the first bearing 17. The second bearing 18 possesses a diameter larger than the one of the first bearing 17.

The output shaft 22 is supported, at its axially intermediate portion, by the second bearing 18 so as to be rotatable. The output shaft 22 is supported, at its distal end, by the first bearing 17 so as to be rotatable. The teeth 14a of the sector gear 14 are gear-meshed with the pinion gear 13 between the auxiliary frame 16 and the base frame 5b.

As illustrated in FIG. 4, the output shaft 22 is formed, at a distal end at the side of the pinion gear 13, with two parallel flat surfaces 22a. A spiral spring 39 is arranged so as to surround the distal end of the output shaft 22. As illustrated in FIG. 9, an inner end 39a of the spiral spring 39 is shaped so as to face approximately in parallel and forms a bore, into which the distal end of the output shaft 22 is inserted and which comes in contact with the flat surfaces 22a of the output shaft 22. The outer end 39b of the spiral spring 39 is engaged with a latch shaft 40 supported between the auxiliary frame 16 and the base frame 5b. Therefore, biasing force of the spiral spring 39 applies a predetermined amount of rotational torque to the output shaft 22 with the fulcrum of the base frame 5b. The rotational torque then operates to lift up the base frames 5a and 5b.

Described below is an operation of the seat adjusting apparatus for a vehicle provided with the clutch apparatus 11 described above. As illustrated in FIG. 4, once an operator or user rotates the operating lever 12 in a direction for lifting up the seat cushion 1a, the input side member 24 attached with the operating lever 12 rotates integrally with the operating lever 12. In response to rotation of the input side member 24, the inner race 25 illustrated in FIG. 7 rotates for example clockwise direction, the first rollers 33 arranged between the cam surface 25a of the inner race 25 and the outer race 32a of the control member 32 are engaged at the wedge-shaped clearance. Therefore, rotation of the inner race 25 is transmitted to the control member 32. As described above, in the first clutch mechanism 41, when the operating lever 12 is driven to operate, operation force of the operating lever 12 is transmitted from the input side member 24 to the control member 32.

Once the control member 32 rotates, the first engagement portions 32b of the control member 32 in FIG. 5 come in contact with side surfaces of the corresponding fitting grooves 23b of the rotor cam 23, wherein the rotor cam 23 is rotated in the clockwise direction in FIG. 5. Here, the second rollers 35, which are arranged between the cam surface 23a of the rotor cam 23 and the inner peripheral surface 21e of the case 21, are pushed by the second engagement portions 32c in the rotational direction of the rotor cam 23. Therefore, the second rollers 35 are not locked at the wedge-shaped clearance in each space so that the second rollers 35 are movable. That is, the output shaft 22 rotates in response to operation of the operating lever 12. In such circumstances, because the clearance defined between each second roller 35 and the corresponding second engagement portion 32c is smaller than the clearance defined in the circumferential direction between the base portion of each spring portion 36a and the corresponding first engagement portion 32b, once the control member 32 rotates, the second engagement portions 32c push the second rollers 35 in the circumferential direction and the first engagement portions 32b then push wall surfaces of the fitting grooves 23b, wherein the output shaft 22 rotates smoothly. As described above, in the second clutch mechanism 42, when the operating lever 12 is driven to operate, operation force of the operating lever 12 is transmitted to the output shaft 22 from the control member 32. Therefore, the sector gear 14, which is engaged with the pinion gear 13 of the output shaft 22, is rotated. The lifter links 7a and 7b pivotably rotate via the driving link 15 on the basis of rotation of the sector gear 14. As a result, the base frames 5a, 5b and the seat cushion 1a are lifted up. Here, biasing force of the spiral spring 39 exerts in a direction for assisting rotation of the output shaft 22, wherein operation force of the operating lever can be reduced.

Once the operating lever 12 is released from being operated, the output shaft 22 rotates counterclockwise in FIG. 5 due to load such as the weight of the seat 1 and/or a weight of an occupant. Here, the output shaft 22 and the rotor 23 rotate integrally. In response to rotation of the rotor cam 23, likewise as the above, the second rollers 35, which are arranged between the cam surface 23a of the rotor cam 23 and the inner peripheral surface 32d of the case 21, are locked at the wedge-shaped clearance so as not to move. Because the case 21 is secured to the base frame 5b, the output shaft 22 is prevented from rotating. That is, in the second clutch mechanism 42, when the operating lever 12 is not driven to operate, the output shaft 22 is restrained from rotating. Here, because the clearance defined between the second rollers 35 and the corresponding first engagement portion 32b is smaller than the clearance defined in the circumferential direction between the base portion of each spring portion 36a and the corresponding first engagement portion 32b, the second rollers 35 are firmly locked at the wedge-shaped clearance so as not to move while the first engagement portions 32b of the control member 32 are not pushed by the wall surfaces of the fitting grooves 23b.

Upon the operating lever 12 is released from being operated as described above, the return member 31 and the input side member 24 are biased by the first torsion spring 37 and the second torsion spring 38 to rotate back to the neutral positions. Here, the first rollers 33 rotate, by the engagement portions 31b of the return member 31, in the same rotational direction as the return member 31 and the input side member 24, wherein the first rollers 33 are not locked and are movable. Therefore, the first rollers 33 are not restrained from returning to the neutral position. That is, in the first clutch mechanism 41, when the operating lever 12 returns to the original position, torque transmitting between the input side member 24 and the control member 32 is cut off.

Even when the operating lever 12 rotated to lift up the seat returns to the neutral position, the clutch mechanism 11 operates in the same manner as the case where the operating lever 12 is released from being operated. Therefore, the rotation of the operating lever 12 is not restrained. Further, when the operating lever 12 rotates to lift down the seat, the operating lever 12 rotates in a different rotational direction and yet in the same manner as described above. Therefore, the explanation will be omitted herein.

According to the embodiment of the present invention, the following effects can be obtained as described above.

(1) In the first clutch mechanism 41, force is transmitted from a radially inner side toward a radially outer side. In the second clutch mechanism 42, force is transmitted from a radially outer side toward a radially inner side. Being compared with a structure in which, also in the first clutch mechanism, force is transmitted from the radially outer side toward the radially inner side, a difference in a radius between the first clutch mechanism 41 and the second clutch mechanism 42 turns to be reduced. Therefore, torsional force, which may be generated between the first clutch mechanism 41 and the second clutch mechanism 42 upon transmitting the operation force, is reduced, wherein there is no need to reinforce the control member 32 in consideration of torsional force and the apparatus can be downsized.

(2) When the control member is positioned at a radially inner side of the input side member as described in JP2002-54658A, the control member needs to extend from the inner side of the rollers of the first clutch mechanism to the rollers of the second clutch mechanism positioned outside of the rollers of the first clutch mechanism. As a result, the control member turns to be disposed in the axial direction between the rollers of the first and second clutch mechanisms, which may make it difficult to arrange the rollers closely in the axial direction. On the other hand, according to the embodiment of the present invention, the control member 32 is arranged at a radially outer side of the input member 24, wherein the control member 32 is not disposed between the first rollers 33 of the first clutch mechanism 41 and the second rollers 35 of the second clutch mechanism 42. That is, each first roller 33 and each second roller 35 are arranged in a manner that an end portion of each first roller 33 overlaps an end portion of the corresponding second roller 35, wherein the first rollers 33 and the second rollers 35 are readily arranged in the vicinity in the axial direction.

Further, in situations where the first rollers 33 of the first clutch mechanism 41 and the second rollers 35 of the second clutch mechanism 42 are arranged in vicinity in the axial direction, an operation force transmitting path between the first clutch mechanism 41 and the second clutch mechanism 42 upon rotation of the operating lever 12 is shortened, compared to a case in which other components are positioned between the first clutch mechanism 41 and the second clutch mechanism 42. This improves transmitting efficiency of operation force.

(3) Because the return springs 37 and 38, which return the input member 24 to the neutral position, are arranged in the vicinity to the operating lever 12 in the axial direction, the return springs 37 and 38 are positioned axially away from the first clutch mechanism 41 which transmits biasing force of the return springs 37 and 38 to the input side member 24. As a result, biasing force of the return springs 37 and 18 is efficiently transmitted to the input side member 24.

(4) The control member 32 is formed with the stepped portion 32d which extends radially at a portion where radially outward force of the first clutch mechanism 41 is applied. Therefore, the control member 32 can appropriately receive the force.

(5) The inner circumferential surface 21g of the case 21 receives pressure which the control member 32 receives from the first clutch mechanism 41, which restrains a radial directional deformation of the control member 32. Therefore, compared with a case in which only the control member 32 receives pressure, the control member can be thin-walled.

(6) The case 21 includes the stepped portion 21 extending radially at a portion where the case 21 receives a radially outward force of the first clutch mechanism 41. Therefore, the case 21 can receives the force appropriately. For example, in the seat adjusting apparatus for a vehicle disclosed in JP2002-54658A, it is possible to adjust the height or the surface level of the seat cushion by inputting torque of the operating lever in a normal or reverse direction. Further the apparatus includes the first clutch mechanism and the second clutch mechanism, which retain a position of the seat cushion in situations where the operating lever is released.

The first clutch mechanism transmits operation fore of the operating lever from the input side member connected to the operating lever to the control member. When the operating lever is not operated, the first clutch mechanism discontinues force transmission between the control member and the input side member. Further, the second clutch mechanism transmits operation force of the operating lever from the control member to the output shaft. When the operating lever is not driven to operate, the second clutch mechanism locks the output shaft from rotating.

In the second clutch mechanism, the outer peripheral surface of the output shaft is formed with the cam surface. There are the multiple rollers between the cam surface and the inner circumferential surface of the case arranged at the side of the outer periphery of the output shaft. A wall portion extending radially from the control member is arranged axially in the vicinity of the wall portion extending radially from the output shaft. A pillar arranged between the rollers is formed at the outer peripheral edge of the wall portion of the control member, while a protruding pin is formed at the wall portion of the control member. The wall portion of the output shaft is formed with a recessed pinhole into which the pin is fitted.

As described above, when the control member rotates in response to inputting of operation force into the operating lever, the pillar releases the rollers from a locked state and the pin of the control member is engaged with the pinhole of the output shaft, wherein the output shaft rotates. Further, when the seat cushion is applied with force and the output shaft rotates, the rollers are engaged between the cam surface of the output shaft and the control member, wherein the output shaft is prevented from being rotated.

JP2003-93187A (FIGS. 17-19)

However, according to the conventional structure, the pin of the control member is engaged with the pinhole of the output shaft so that the control member rotates integrally with the output shaft. However, the pinhole is a recessed groove opening towards the axially one side surface of the wall portion of the output shaft. Therefore, for example in case where the control member is mated with the output shaft with a looseness in the axial direction, there has been possibility that the pin is disengaged from the pinhole. If the pin and the pinhole can be axially long enough, they are not disengaged from each other. However, in such cases, the wall portion of the output shaft is needed to be thicker and the apparatus itself may be enlarged, which is not preferable.

The present invention has been made in view of the above circumstances and provides a seat adjusting apparatus for a vehicle which ensures a circumferential directional engagement between the control member and the output shaft at a not-enlarged size.

(1) The first engagement portions 32b of the control member 32 are arranged at the respective grooves 23b penetrating axially at the rotor cam 23. Therefore, even if the axial thickness of the rotor cam 23 is not enlarged, it is possible to ensure a circumferential directional engagement between the rotor cam 23 (output shaft 22) and the control member 32.

(2) The control member 32 comes in contact with the rotor cam 23 in the axially direction only via a bent portion of the second engagement portions 32c. For example, being compared with a structure in which the first engagement portions are formed at a wall portion radially extending at the control member 32 disclosed in JP2002-54658A, it is possible to reduce the contact surface. Therefore, as the number of contact surfaces between the control member 32 and the rotor cam 23 are increased, friction at the contact surfaces prevents rotational force of the rotor cam 23 (output shaft 22) from being transmitted to the control member 32.

(3) When rotational force is applied to the output shaft 22, the second rollers 35 are biased by the spring portions 36a and are engaged between the cam surface 23a of the rotor cam 23 and the inner circumferential surface 21e of the case 21, prior to a contact of the wall surfaces of the grooves 23b of the rotor cam 23 with the first engagement portions 32b. Therefore, it is possible to reliably prevent rotation of the output shaft 22.

The embodiment of the present invention is not limited to the above and can be modified as follows.

According to the embodiment of the present invention, the ends of the first rollers 33 of the first clutch mechanism 41 and ends of the second rollers 35 of the second clutch mechanism 42 are arranged so as to overlap or lie on each other in the axial direction. Alternatively. The end of each first roller 33 and the end of each second roller 35 can be arranged at the same position in the axial direction.

According to the embodiment, the case 21 of the clutch apparatus 11 is directly secured to the base frame 5b. However, the case 21 can be secured to a base supporting the output shaft 22 so as to unitize the clutch apparatus.

According to the embodiment, the seat cushion 1a is biased by the spiral spring 39 so as to be lifted up. However, the seat cushion 1a can be biases by another elastic member such as a torsion bar.

According to the above embodiment, the grooves 23b are formed at the outer peripheral surface of the rotor cam 23, which serve as engagement portions. However, the engagement portion is not limited to the above. For example, a through hole, which penetrates axially at the rotor cam, can be employed as the engagement portion.

According to the above embodiment, the base portion of each spring portion 36a biasing the second rollers 35 is arranged in the corresponding groove 23b of the rotor cam 23. However, as far as the spring member is arranged between the second rollers 35 adjacent in the circumferential direction, the spring portion 36a does not have to be housed in the groove 23b. It is appropriate that a clearance between the second roller 35 and the second engagement portion 32c is smaller than a circumferential directional clearance between the groove 23b and the first engagement portion 32b. Here, likewise as the above embodiment, when the output shaft 22 receives rotational force, the second rollers 35 are biased by the spring member and engaged between the cam surface 23a of the rotor cam 23 and the inner circumferential surface 21e of the case 21, the output shaft is prevented from rotating.

According to the above embodiment, the spring portions 35a of the second looseness preventive spring 36 are integrally formed with the connecting portion 36b. However, the spring portions 36a can be separated from the connecting portion 36b.

According to the above-described structure, in the first clutch mechanism, force is transmitted from a radially inner side toward a radially outer side. In the second clutch mechanism, force is transmitted from a radially outer side toward a radially inner side. Being compared with a structure in which, also in the first clutch mechanism, force is transmitted from the radially outer side toward the radially inner side, a difference in a radius between the first clutch mechanism and the second clutch mechanism turns to be reduced. Therefore, torsional force, which may be generated between the first clutch mechanism and the second clutch mechanism upon transmitting the operation force, is reduced, wherein there is no need to reinforce a member in consideration of torsional force and the apparatus can be downsized.

The first clutch mechanism includes a first roller, which can transmit force between a cam surface of the input side member and an inner circumferential surface of the control member, and the second clutch mechanism includes a second roller, which can transmit force between the inner circumferential surface of the control member and a cam surface of the rotor connected with the output shaft. An end of the first roller and an end of the second roller are arranged so as to overlap in an axial direction or are arranged at the same position.

According to the above-described structure, the first clutch mechanism and the second clutch mechanism are arranged in the vicinity thereof. Therefore, being compared with a structure in which at least one member is disposed between the first clutch mechanism and the second clutch mechanism, an operation force transmitting path between the first clutch mechanism and the second clutch mechanism is shortened when the operating member is driven to operate, wherein operation force transition efficiency is improved.

The seat adjusting apparatus further includes returning member for returning the input side member to a neutral position when the input side member is released and positioned axially adjacent to the operating member.

According to the above-described structure, the returning member, which returns the input side member to a neutral position, is arranged adjacent to the operating member in the axial direction. As a result, basing force of the returning member is efficiently transmitted to the input side member.

The control member includes a stepped portion extending radially at a radially outer side of the first clutch mechanism.

According to the above-described structure, it is possible for the control member to receives the force appropriately.

The second clutch mechanism includes: a static member restraining the output shaft from rotating when the operating member is not driven to operate. A radius of a portion of the control member, in which the first clutch mechanism is accommodated, is identical to a radius of an inner circumferential surface of the static member.

According to the above-described structure, it is possible to restrain radial deformation of the control member. Being compared with a case in which only the control member receives the pressure, the control member can be thinner-walled.

The static member includes a stepped portion extending radially at a radially outer side of the first clutch mechanism.

According to the above-described structure, the static member can receives the force appropriately.

As described above, the seat adjusting apparatus for a vehicle can be downsized.

The principles, of the preferred embodiment and mode of operation of the present invention have been described in the foregoing specification. However, the invention, which is intended to be protected, is not to be construed as limited to the particular embodiment disclosed. Further, the embodiment described herein are to be regarded as illustrative rather than restrictive. Variations and changes may be made by others, and equivalents employed, without departing from the spirit of the present invention. Accordingly, it is expressly intended that all such variations, changes and equivalents that fall within the spirit and scope of the present invention as defined in the claims, be embraced thereby.

1. A seat adjusting apparatus for a vehicle having a seat lifted up and down in response to a rotation of an output shaft following an operation of an operating lever, the seat adjusting apparatus comprising:
an input side member connected to the operating lever and rotatably supported by the output shaft;
a control member arranged at a radially outer side of the input side member;
a first clutch mechanism transmitting operation force of the operating member from the input side member to the control member when the operating lever is driven to operate and discontinuing force transmission between the input side member and the control member when the operating member returns to an original position; and
a second clutch mechanism transmitting the operation force of the operating member from the control member to the output shaft when the operating member is driven to operate and restraining the output shaft from rotating when the operating member is not driven to operate.

2. A seat adjusting apparatus for a vehicle according to claim 1, wherein the first clutch mechanism includes a first roller transmitting force between a cam surface of the input side member and an inner circumferential surface of the control member, and the second clutch mechanism includes a second roller transmitting force between the inner circumferential surface of the control member and a cam surface of the rotor connected with the output shaft, wherein an end of the first roller and an end of the second roller are arranged so as to overlap in an axial direction or are arranged at the same position.

3. A seat adjusting apparatus for a vehicle according to claim 1, further comprising:
returning member for returning the input side member to a neutral position when the input side member is released and positioned axially adjacent to the operating member.

4. A seat adjusting apparatus for a vehicle according to claim 1, wherein the control member includes a stepped portion extending radially at a radially outer side of the first clutch mechanism.

5. A seat adjusting apparatus for a vehicle according to claim 1, wherein the second clutch mechanism includes: a static member restraining the output shaft from rotating when the operating member is not driven to operate, and a radius of a portion of the control member, in which the first clutch mechanism is accommodated, is identical to a radius of an inner circumferential surface of the static member.

6. A seat adjusting apparatus for a vehicle according to claim 5, wherein the static member includes a stepped portion extending radially at a radially outer side of the first clutch mechanism.

7. A seat adjusting apparatus for a vehicle according to claim 2, further comprising:
returning member for returning the input side member to a neutral position when the input side member is released and positioned axially adjacent to the operating member.

8. A seat adjusting apparatus for a vehicle according to claim 2, wherein the control member includes a stepped portion extending radially at a radially outer side of the first clutch mechanism.

9. A seat adjusting apparatus for a vehicle according to claim 3, wherein the control member includes a stepped portion extending radially at a radially outer side of the first clutch mechanism.

10. A seat adjusting apparatus for a vehicle according to claim 7, wherein the control member includes a stepped portion extending radially at a radially outer side of the first clutch mechanism.

11. A seat adjusting apparatus for a vehicle according to claim 2, wherein the second clutch mechanism includes: a static member restraining the output shaft from rotating when the operating member is not driven to operate, and a radius of a portion of the control member, in which the first clutch mechanism is accommodated, is identical to a radius of an inner circumferential surface of the static member.

12. A seat adjusting apparatus for a vehicle according to claim 3, wherein the second clutch mechanism includes: a static member restraining the output shaft from rotating when the operating member is not driven to operate, and a radius of a portion of the control member, in which the first clutch mechanism is accommodated, is identical to a radius of an inner circumferential surface of the static member.

13. A seat adjusting apparatus for a vehicle according to claim 4, wherein the second clutch mechanism includes: a static member restraining the output shaft from rotating when the operating member is not driven to operate, and a radius of a portion of the control member, in which the first clutch mechanism is accommodated, is identical to a radius of an inner circumferential surface of the static member.

14. A seat adjusting apparatus for a vehicle according to claim 7, wherein the second clutch mechanism includes: a static member restraining the output shaft from rotating when the operating member is not driven to operate, and a radius of a portion of the control member, in which the first clutch mechanism is accommodated, is identical to a radius of an inner circumferential surface of the static member.

15. A seat adjusting apparatus for a vehicle according to claim 8, wherein the second clutch mechanism includes: a static member restraining the output shaft from rotating when the operating member is not driven to operate, and a radius of a portion of the control member, in which the first clutch mechanism is accommodated, is identical to a radius of an inner circumferential surface of the static member.

16. A seat adjusting apparatus for a vehicle according to claim 9, wherein the second clutch mechanism includes: a static member restraining the output shaft from rotating when the operating member is not driven to operate, and a radius of a portion of the control member, in which the first clutch mechanism is accommodated, is identical to a radius of an inner circumferential surface of the static member.

17. A seat adjusting apparatus for a vehicle according to claim 1, wherein the input side member is cylindrically shaped, the control member is cylindrically shaped and is arranged at the outer peripheral side of the input side member, the first clutch mechanism discontinues force transmission between the input side member and the control member when the operating member is not driven to operate, the second clutch mechanism includes: a rotor connected to the output shaft and formed with an engagement portion penetrating in the axial direction; a static member having an inner circumferential surface facing radially a cam surface formed at an outer peripheral surface of the rotor; a plurality of rotors arranged in a wedge-shaped space defined between the cam surface and the inner circumferential surface; and an engagement portion extending axially from the control member and disposed in the engagement portion of the rotor, and the second clutch mechanism locks the output shaft not to rotate by the inner circumferential surface of the static member when the operating member is not driven to operate.

18. A seat adjusting apparatus for a vehicle according to claim 17, wherein the engagement portion of the control member includes a first engagement portion axially and continuously formed at the control member and disposed in the engagement portion of the rotor; and a second engagement portion bent at the control member and arranged at an end portion of the wedge-shaped space of the second clutch mechanism, in which a distance between the cam surface and the inner circumferential surface is reduced.

19. A seat adjusting apparatus for a vehicle according to claim 18, wherein a clearance defined between each rotor and the second engagement portion is smaller than a clearance between the engagement portion of the rotor and the first engagement portion of the control member.

20. A seat adjusting apparatus for a vehicle according to claim 18, wherein the second clutch mechanism includes a spring member biasing each rotor towards the end portion at which the distance between the cam surface and the inner circumferential surface is reduced, a base portion of the spring member is inserted into the engagement portion of the control member, the first engagement portion is arranged at the base portion in a circumferential direction, and a clearance between each rotor and the second engagement portion is designed to be smaller than a clearance circumferentially defined between the base portion of the spring member and the first engagement portion.
